(19) United States
(12) Patent Application Publication
(10) Pub. No.: US 2008/0241454 A1
(43) Pub. Date: Oct. 2, 2008

(54) FOLDER OR FOLDABLE SHEET FOR FASTENING ON A PRINTED PRODUCT OR ON ANOTHER FLAT OBJECT

(75) Inventor: Ernst Mockli, Fehraltdorf (CH)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 11/867,805

(22) Filed: Oct. 5, 2007

(30) Foreign Application Priority Data
Oct. 6, 2006 (CH) 1603/06

(51) Int. Cl. B32B 33/00

(52) U.S. Cl. 428/41.8

(57) ABSTRACT

A folded or foldable sheet (1) which is divided by a fold line (2) into two fold parts (1.1 and 1.2), on the inner side of the one fold part (1.1) comprises an adhesive region (3), in which it is coated with a pressure-sensitive adhesive. In order for the sheet to be able to be conveyed and stacked in a folded manner, without the two fold parts (1.1, 1.2) sticking to one another, the other fold part (1.2) comprises an anti-stick region (4) which in the folded condition of the sheet, lies on the adhesive region (3) and completely covers this. The anti-stick region (4) is coated with a material which does not stick, or only to a small extent, to the pressure-sensitive adhesive, or it is a recess. The sheet may be stored and conveyed in a folded manner, and despite this may be fastened on another object, for example to a printed product, without further provisions or merely by way of a slight pressing.

### BACKGROUND OF THE INVENTION

The invention lies in the field of printing technology, and the further processing of printed products, and relates to a folded or a foldable sheet, according to the preamble of the independent patent claim. The sheet is folded along an effective fold line and/or along a potential fold line. It has an inner side and an outer side and two fold parts, which are separated from one another by the fold line. The sheet is in particular suitable for fastening on a printed product or on another flat object.

International Patent Application No. PCT/CH2006/000543 not published before the priority date of this application, describes a method for adding an attachment to multi-sided, folded or bound printed products, which thus have a specific fold edge or back edge. The attachment may also be fastened on the printed product. The printed products for example are newspapers, magazines or brochures, and the attachment is folded along a fold line. It is supplied in a folded state, and then opened. Directly after the opening, it is placed on the printed product in a manner such that it lies on the front side or rear side of the printed product or on its fold edge or back edge. Its fold line is directed to the fold edge or back edge of the printed product. For fastening the attachment deposited on the fold edge or back edge of the printed product, it is suggested to deposit an adhesive on the region of the fold edge or back edge or on the fold edge or back edge itself before placing the attachment on the front side or rear side of the printed product, and to press the attachment after the placing, as the case may be, onto the adhesive. It is furthermore suggested to fasten the attachment by way of a stitching/stapling on the printed product.

It would of course also be possible in the method described briefly above, to deposit an adhesive on the inner side of the attachment for fastening the attachment on the printed product. An activatable adhesive would be simple to introduce into the attachment, but would have to be activated in an additional step (heat treatment, irradiation etc.). A pressure-sensitive adhesive could only be introduced into the already opened attachment directly before the placing-on, which would not be simple.

### SUMMARY OF THE INVENTION

It is an object of the invention to provide a folded sheet, which for example is suitable as an attachment in the method described briefly above, and which is readily equipped for the fastening on the front side or the rear side of the printed product or its fold edge or rear edge, such that no provisions need to be made on the printed product for the fastening, and that despite this, the attachment for its fastening on the printed product after the placing-on, at the most, only further needs to be slightly pressed, in order to be fastened on the printed product in a satisfactory manner. It is a further object of the invention to design such sheets that can be stacked. The sheet according to the invention should not only be suitable for the initially briefly described method for attaching an attachment on a folded or bound printed product in the mentioned way and manner, but is should also be able to be applied in other methods, in which a folded sheet is to be fastened on a printed product or on another flat object.

This object is achieved by the folded or foldable sheet as is defined in the patent claims.

The term “sheet” in the present invention is to be used in a very general manner. The term “sheet” is not only to be understood as a sheet which is folded or foldable once or more than once, but also as a multi-layered, pamphlet-like formation which effectively consists of more than one sheet.

The folded or foldable sheet according to the invention has an inner side and an outer side, and is folded along an effective fold line, and/or foldable along a potential fold line. It comprises two fold parts which are separated from one another by the fold line. An adhesive region is arranged on the inner side of the first fold part, in which the sheet is coated with a pressure-sensitive adhesive. This means that the adhesive region of the first fold part is permanently sticky without activation, and sticks by way of contacting and, as the case may be, a slight pressing on the other surface. To prevent the adhesive region from sticking on the inner side of the second fold part of the sheet when the sheet is folded, an anti-stick region is arranged on the inner side of the second fold part, in a manner such that the two regions lie essentially on one another when the sheet is folded. This therefore means that the adhesive region and the anti-stick region are arranged in an essentially mirror-symmetric manner relative to the fold line. The anti-stick region thereby may be equally large as the adhesive region, but is advantageously somewhat larger and completely covers the adhesive region when the two regions lie on one another in the folded sheet. The anti-stick region is designed in a manner such that the pressure-sensitive adhesive of the adhesive region may not stick thereto, or may only stick thereto in a manner such that the two regions can be separated from one another whilst applying a very small peeling force.

The sheet in the anti-stick region consists of the anti-stick material (e.g. silicone) or is coated with such a material. Material pairings of pressure-sensitive adhesive and anti-stick material per se are known to the man skilled in the art. The anti-stick region may however also be an opening in the second fold part of the sheet.

The sheet according to the invention, in an at least a partly opened condition, may be fastened on a printed product or on another flat object in a very simple manner, specifically simply in that it is pressed onto the printed product or onto the object in the region of the adhesive region. The sheet according to the invention may however be opened without any problem by way of moving the two fold parts, which do not stick to one another or only to a very small extent, thanks to the pairing of the adhesive region/anti-stick region, away from one another. It is furthermore also possible to stack the sheets according to the invention in the folded condition, without the sheets sticking to one another. If the anti-stick region is designed as a recess, then one must adapt the extent of the anti-stick region and thus also of the adhesive region to the thickness and flexibility of the sheet material for a non-stick stacking. As will yet be shown, it is therefore advantageous with thin and/or flexible sheet material to provide a plurality of smaller anti-stick regions and corresponding adhesive regions, instead of a single, relatively large anti-stick region.

The sheet according to the invention consists for example of paper, of a paper-like material or of a plastic. It is a simple sheet or may consist of several layers, it may also be folded in a multiple manner or be designed as a pamphlet, wherein the adhesive region and the anti-stick region are arranged in the inner side, for example of the middle sheet of the pamphlet. The sheet according to the invention may be printed or also not, wherein it is indeed possible to print also the adhesive region (below the pressure-sensitive adhesive) and, if it is not designed as a recess, also the anti-stick region (also below a corresponding coating of sheet material). The sheet according to the invention is for example designed as an attachment which is to be deposited and fastened on the fold edge or back edge of a printed product (e.g. newspaper, magazine or brochure). In this embodiment, it above all serves for advertising purposes. The sheet according to the invention may however also be a part sheet of a multi-sided printed product to be manufactured by collection, or an envelope sheet for a printed product or for another flat object (e.g. plastic container for CD or other flat product).

### BRIEF DESCRIPTION OF THE DRAWINGS

Exemplary embodiments of the sheet according to the invention are described in detail by way of the following figures.

FIGS. 1A and 1B are a first embodiment of the sheet according to the invention, in a non-folded and in a folded condition;

FIGS. 2 and 3 are two variants of a second embodiment of the sheet according to the invention, in the folded condition;

FIG. 4 is a stack of folded sheets of the embodiment according to FIGS. 2 and 3, in section;

FIGS. 5 and 6 are two further embodiments of the sheet according to the invention, in the non-folded condition; and

FIG. 7 is a bound printed product with a sheet attached to its back edge.

### DETAILED DESCRIPTION OF THE EMBODIMENTS

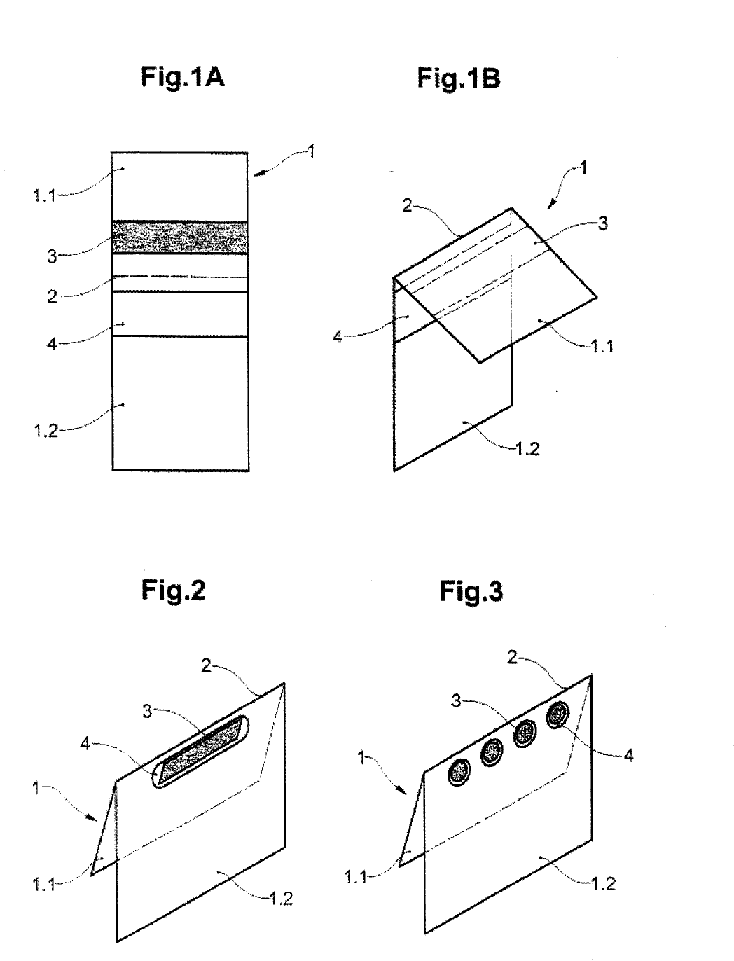

FIGS. 1A and 1B show a first exemplary embodiment of the sheet according to the invention. The sheet is shown in FIG. 1A in a non-folded condition and specifically from its inner side, and in FIG. 1B in a folded or creased condition.

Sheet 1 comprises a fold line 2 (in the unfolded condition: potential fold line; in the folded condition: effective fold line), which divides the sheet 1 into two fold parts 1.1 and 1.2. If the two fold parts 1.1 and 1.2 have different extensions transverse to the fold line 2, as is represented in the figure, then the sheet 1 may be opened in a particularly simple manner.

The inner side of the first fold part 1.1 is provided with an adhesive region 3, the second fold part 1.2 with an anti-stick region 4, which in this case consists of a material which does not stick to the pressure-sensitive adhesive of the adhesive region 3, or is coated with such. Of course, the complete sheet 1 may also consist of the non-sticking material. The anti-stick region 4 is somewhat larger than the adhesive region and is arranged in a mirror-symmetrical manner to the adhesive region 3 relative to the fold line, in a manner such that it completely covers the adhesive region 3 when the sheet 1 is guided along the fold line 2.

The sheet 1 according to FIGS. 1A and 1B may be printed on both sides. Thereby, the adhesive region 3 (below the transparent pressure-sensitive adhesive) and/or the anti-stick region 4 (on a non-stick material or below a corresponding coating) may be printed.

FIG. 2 shows a further exemplary embodiment of the sheet 1 according to the invention in the folded condition. The same elements are indicated with the same reference numerals as in FIGS. 1A and 1B. The anti-stick region 4 in this case is designed as a recess in the second fold part 1.2.

FIG. 3 shows a further embodiment of the sheet 1 according to the invention, with which a plurality of adhesive regions 3 and anti-stick regions 4 are provided, wherein the anti-stick regions 4 are again designed as recesses in the second fold part 1.2.

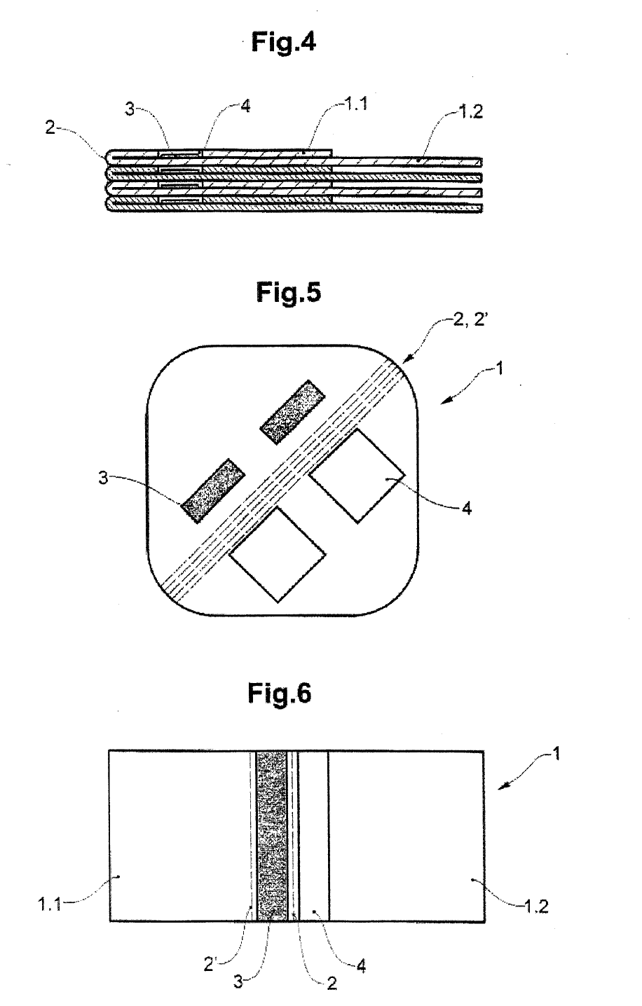

FIG. 4 shows a section through a stack of sheets, as is illustrated for example in FIGS. 2 and 3. It is evident from this, that although the anti-stick regions 4 are formed as recesses, the pressure-sensitive adhesive of the adhesive regions 3 in the stack may not stick on the outer side of the first fold part 1.1 of an adjacent sheet, since the second fold part 1.2 of the sheet lies therebetween. It is evident from FIG. 4, that the size of the anti-stick region 4 and thus also the size of the adhesive region 3, are to be adapted to the intrinsic stiffness or the flexibility and thickness of the sheet material. With a very stiff sheet material, the regions 3, 4 may be almost infinitely large independently of the thickness of the sheet material, since the first fold part 1.1 of a sheet would not bend into the recess of the second fold part 1.2 of an adjacent sheet and come into contact with the pressure-sensitive adhesive by way of this. If however the sheet material is flexible, and in particular if it is thin and flexible, the first fold part of a sheet would have the tendency to bend into the recess of the second fold part 1.2 of the adjacent sheet, and come into contact with the pressure-sensitive adhesive, which may only be avoided by way of suitably small dimensions of the anti-stick region 4.

FIG. 5 shows further aspects of the invention by way of a further embodiment of the sheet 1 according to the invention, in order to show that the sheet 1 according to the invention does not need to be rectangular, does not need to be folded perpendicular to its edges and may also have several fold lines, wherein in the folded condition it is folded about one of the fold lines (effective fold line), and the other fold lines are designed as potential fold lines (scratched, corrugated or perforated). In other words, this means that the invention is not restricted to any certain shape of sheet or to any certain sheet material.

The sheet 1 shown in FIG. 5 for example has a square shape with rounded corners, comprises a plurality of parallel fold lines 2, 2′ which are distanced to one another, and these are aligned in a diagonal manner. The two anti-stick regions 4 are dimensioned in a manner such that they cover the adhesive regions 3 in the folded condition of the sheet 1, independently of along which fold line the sheet 1 is folded. Thus, the one or the other of the fold lines is the effective fold line 2 and the others are potential fold lines 2′, depending on the folding.

It is recommended to design the adhesive region 3 and the anti-stick region 4 small and as close as possible to the fold line or to the fold lines, particularly if the anti-stick region 4 is designed as a recess and the sheet 1 is printed.

Sheets with a plurality of parallel fold lines which are distanced to one another are in particular suitable for depositing on a relatively wide fold edge or back edge of a printed product, since they may be creased along all fold lines, and bend in a polygonal manner about such an edge by way of this.

FIG. 6 shows a last exemplary embodiment of the sheet 1 according to the invention. This has two parallel fold lines distanced to one another, wherein it is to be folded along the fold line 2 (effective fold line) and the other fold line is a potential fold line 2′. The adhesive region 3 is arranged between the two fold lines 2 and 2′, and the anti-stick region 4 is arranged mirror-symmetrically to the adhesive region 3 relative to the effective fold line 2. If the sheet 1 is creased along both fold lines according to FIG. 6, it comprises a back surface whose inner side is sticky. This sheet 1 is thus in particular suitable for placing on a rear edge of a printed product which for example is bound by adhesive, or on a similarly designed edge of another flat object, wherein the width of this edge is roughly equal to the distance between the two fold lines 2 and 2′ of the sheet 1. The sheet 1 according to FIG. 6 may be stored and supplied in a folded manner along the fold edge 2 in the simplest manner. It may be opened in a simple manner and be put down on a corresponding edge, to which it simply adapts by way of also creasing about the fold line 2′. The adhesive region merely needs to be pressed onto the edge for fastening. The sheet 1 according to FIG. 6 may for example be a cover sheet for a printed product.

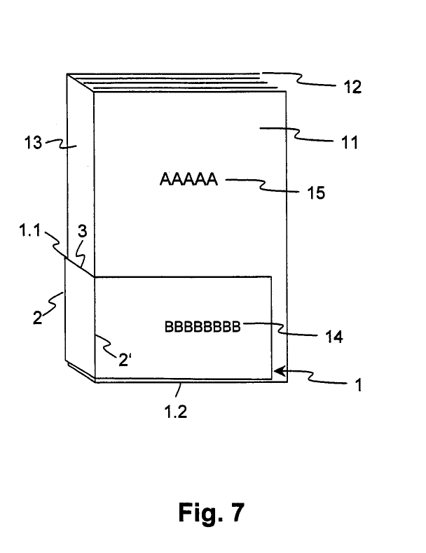

This is shown in FIG. 7. FIG. 7 shows a bound printed product having a front face 11, a rear face 12 and a back edge 13 along which the product is bound. A sheet 1 as shown in FIG. 6 is attached to printed product with the adhesive region 3 being attached to the back edge 13 and the first fold part 1.1 and the second fold part 1.2 partly covering the front face 11, and rear face 12, respectively. The printed product carries a printing 15, here for example the book title, and the sheet 1 may also comprise a printing 14, for example an advertisement or additional information on the printed product. The printing 14 may also be in the adhesive region 3.

1. A folded or foldable sheet with an inner side and an outer side, comprising at least one fold line, said fold line dividing the sheet into a first fold part and a second fold part, wherein the sheet comprises
an adhesive region, said adhesive region being located on the inner side of the sheet on the first fold part of the sheet and comprising a pressure-sensitive adhesive;
an anti-stick region, said anti-stick region being located on the inner side of the sheet on the on the second fold part, wherein said anti-stick region does not stick to the pressure-sensitive adhesive or sticks to the pressure-sensitive adhesive only to a small extent,
wherein the adhesive region and the anti-stick region are arranged essentially mirror-symmetrically to one another relative to the fold line such that the adhesive region and the anti-stick region overlap in a folded state of the sheet, and wherein the anti-stick region is at least equally large as the adhesive region and completely overlaps with the adhesive region when the sheet is folded along the fold line.

2. A sheet according to claim 1, wherein the fold line is a potential fold line marking a line along which the sheet can be folded.

3. A sheet according to claim 1, wherein the adhesive region is coated with a pressure-sensitive adhesive.

4. A sheet according to claim 1, wherein the anti-stick region consists of a material which does not stick to the pressure-sensitive adhesive or sticks to the pressure-sensitive adhesive only to a small extent.

5. A sheet according to claim 1, wherein the anti-stick region is coated with a material which does not stick to the pressure-sensitive adhesive or sticks to the pressure-sensitive adhesive only to a small extent.

6. A sheet according to claims 1, wherein at least one of the adhesive region and the anti-stick region comprise a printing.

7. A sheet according to claim 1, wherein the anti-stick region comprises an opening in the second fold part.

8. A sheet according to claims 1, comprising a plurality of adhesive regions and anti-stick regions.

9. A sheet according to claim 1, comprising a plurality of fold lines which are arranged parallel to one another and are distanced to one another, wherein the anti-stick region is adapted to the adhesive region in a manner such that the anti-stick region covers the whole adhesive region, when the sheet is folded along any one of the fold lines.

10. A sheet according to claim 1, further comprising a further fold line arranged in parallel and distanced to the fold line, wherein the adhesive region is arranged between the fold line and the further fold line.

11. Printed product, comprising a front face, a rear face and an edge, further comprising a sheet according claim 1 as an attachment, which is deposited onto said edge.

12. Printed product according to claim 11, wherein the printed product is at least one of a folded printed product having a fold edge or a bound printed product having a binding edge, and wherein the sheet is attached to the fold edge and the binding edge, respectively.

13. Printed product according to claim 11, wherein the printed product is at least one of a newspaper, a magazine and a brochure.

14. Printed product according to claim 11, wherein the sheet comprises a printing serving as advertisement.

15. Printed product according to claim 11, wherein the sheet acts as a cover sheet for the printed product.

16. Printed product according to claim 11, wherein the printed product is manufactured by way of collecting folded sheets.
